(19) United States
(12) Patent Application Publication
(10) Pub. No.: US 2013/0201526 A1
(43) Pub. Date: Aug. 8, 2013

(54) PRINTING SYSTEM, PRINTING METHOD, AND COMPUTER READABLE MEDIUM

(71) Applicant: Takuma SAITO, Toyoake-shi (JP)

(72) Inventor: Takuma SAITO, Toyoake-shi (JP)

(73) Assignee: Brother Kogyo Kabushiki Kaisha, Nagoya-shi (JP)

(21) Appl. No.: 13/761,120

(22) Filed: Feb. 6, 2013

(30) Foreign Application Priority Data
Feb. 7, 2012 (JP) 2012-024245

(51) Int. Cl. G06F 3/12

(52) U.S. Cl. CPC G06F 3/1267
USPC 358/1.15

(57) ABSTRACT

The data sending terminal control section of a data sending terminal creates job data from image data, the job data being created as a print job that includes the image data and a first print command and as a storage job that includes the image data and a second print command. The data sending terminal control section sends the print job and the storage job created from the same image data to the printing apparatus in this order.

### CROSS REFERENCE TO RELATED APPLICATION

The present application claims priority from Japanese Patent Application No. 2012-024245, which was filed on Feb. 7, 2012, the disclosure of which is herein incorporated by reference in its entirety.

### BACKGROUND OF THE INVENTION

1. Field of the Invention

The present invention relates to a printing system, a printing method, and a computer readable medium.

2. Description of the Related Art

There has been proposed a printing system that includes a printing apparatus and a data sending terminal that sends job data (job) to the printing apparatus. In such a printing system, the data sending terminal creates a job that includes image data and a print command (including, for example, the number of copies), and sends the job to the printing apparatus. The printing apparatus then prints the job.

Further, there is known a printing apparatus that enables the both direct printing and reprinting. In the direct printing, printing is started immediately, upon reception of externally input image data. The reprinting on the other hand is printing using the image data related to the direct printing, which is stored in the printing apparatus for use in possible future printing after the direct printing.

### SUMMARY OF THE INVENTION

The print command for reprinting is not necessarily the same as the print command for direct printing, and a job for direct printing (hereinafter, “print job”), and a job for reprinting (hereinafter, “storage job”) have different contents. It, then, might be possible, for example, to create a storage job by rewriting a print job in a printing apparatus. However, rewriting a print job in the printing apparatus increases the process load on the printing apparatus, and makes it difficult to print the direct printing job at high speed.

Accordingly, it is an object of an embodiment of the present invention to realize the storage of a job in a printing apparatus with a print command different from the print command for direct printing, and the execution of high-speed printing of a print job for direct printing.

A printing system of an embodiment of the present invention includes a printing apparatus and a data sending terminal configured to send data to the printing apparatus. The data sending terminal includes a job creating section, a sending section, and a data sending terminal control section. The job creating section is configured to create job data from image data, the job data being created as a print job that includes the image data and a first print command, and as a storage job that includes the image data and a second print command. The sending section is configured to send the job data to an outside. The data sending terminal control section is configured to control the data sending terminal. The printing apparatus includes a receiving section, an analyzing section, a determining section, a printing section, storage section, and a printing apparatus control section. The receiving section is configured to receive the job data from the outside. The analyzing section is configured to analyze the job data. The determining section is configured to determine whether the analyzed job data is the print job or the storage job using a result of the analysis by the analyzing section. The printing section is configured to print an image on a recording medium according to the image data included in the job data. The storage section is configured to store the job data. The printing apparatus control section is configured to control the printing apparatus. The data sending terminal control section controls the sending section in such a manner that the print job and the storage job created from the same image data are sent to the outside in this order. The printing apparatus control section controls the analyzing section to analyze the job data received by the receiving section in the order received by the receiving section, the printing section to print an image on a recording medium according to the image data of the print job using the first print command of the print job when the determining section determines the job data analyzed by the analyzing section is the print job, and the storage section to store the storage job when the determining section determines the job data analyzed by the analyzing section is the storage job.

A printing method of the present embodiment of the present invention is executed by a printing system that includes a printing apparatus and a data sending terminal configured to send data to the printing apparatus. The method includes a job creating step, a sending step, a receiving step, an analyzing step, a printing step, and a storing step. The job creating step is executed by the data sending terminal of creating job data from image data, the job data being created as a print job that includes the image data and a first print command, and as a storage job that includes the image data and a second print command. The sending step is executed by the data sending terminal of sending to the printing apparatus the job data created in the job creating step. The receiving step is executed by the printing apparatus of receiving the job data sent in the sending step. The analyzing step is executed by the printing apparatus of analyzing the job data received in the receiving step. The determining step is executed by the printing apparatus of determining whether the analyzed job data is the print job or the storage job using a result of the analysis performed in the analyzing step. The printing step is executed by the printing apparatus of printing an image on a recording medium according to the image data of the print job using the first print command of the print job when the determining step determines that the job data sent from the data sending terminal is the print job. The storing step is executed by the printing apparatus of storing the storage job in a storage section when the determining step determines that the job data sent from the data sending terminal is the storage job. The print job and the storage job created from the same image data are sent to the printing apparatus in this order in the sending step. The job data received in the receiving step is analyzed in the analyzing step in the order received in the receiving step.

A non-transitory computer readable medium of an embodiment of the present invention stores a printer driver. The printer driver causes a data sending terminal sending data to a printing apparatus to execute a job creating step and a sending step. The job creating step creates job data from image data, the job data being created as a print job that includes the image data and a first print command, and as a storage job that includes the image data and a second print command. The sending step sends to the printing apparatus the job data created in the job creating step. The print job and the storage job created from the same image data are sent to the printing apparatus in this order.

A printing system of an embodiment of the present invention includes a printing apparatus and a data sending terminal configured to semi data to the printing apparatus. The data transmitting terminal includes a processor and a transmitter. The processor is configured to create job data from image data, the job data being created as a job data for print job that includes the image data and a first print command, and as a job data for storage job that includes the image data and a second print command. The transmitter is configured to transmit the job data to the printing apparatus. The processor controls the transmitter to transmit the job data for the print job and the job data for the storage job, in this order, created from the same image data to the printing apparatus. The printing apparatus includes a receiver, a printing head, a storage unit, and a processor. The receiver is configured to receive the job data. The printing head is configured to print an image on a recording medium according to the image data included, in the job data. The storage unit is configured to store the job data. The processor is configured to control the printing head to print an image on a recording medium according to the image data of the job data for the print job using the first print command of the job data for the print job when the received job data is the job data for the print job. The processor is also configured to control the storage unit to store the job data for the storage job when the received job data is the job data for the storage job.

BRIEF DESCRIPTION OF THE DRAWINGS

Other and further objects, features and advantages of the invention will appear more fully from the following description taken in connection with the accompanying drawings in which:

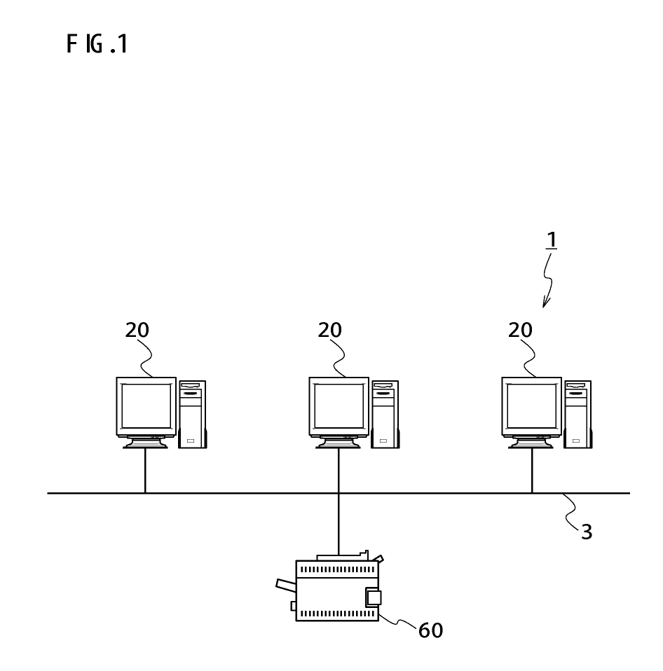

FIG. 1 is a block diagram of a printing system according to First Embodiment.

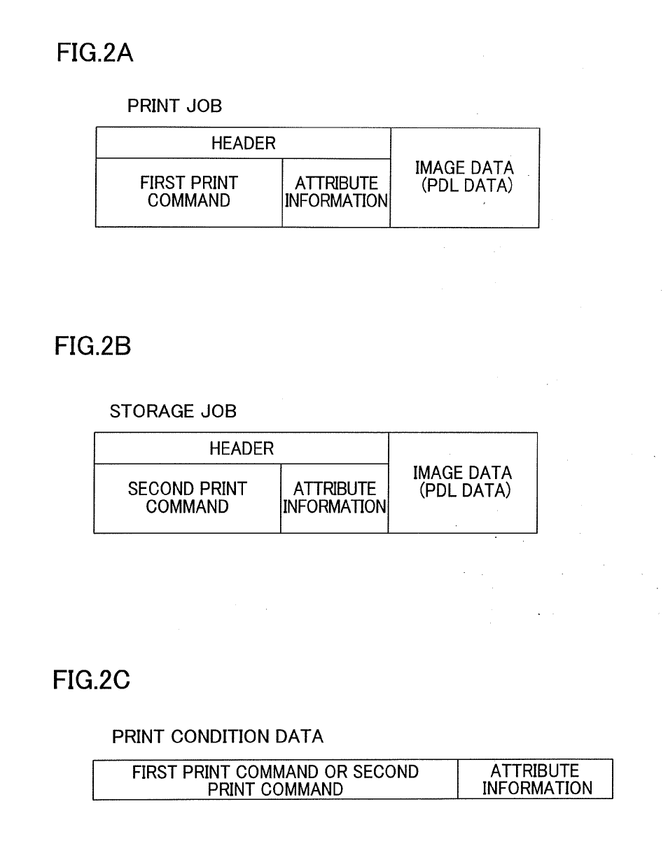

FIG. 2A is a diagram depicting a data structure of a print job.

FIG. 2B is a diagram depicting a data structure of a storage job.

FIG. 2C is a diagram depicting a data structure of print condition data.

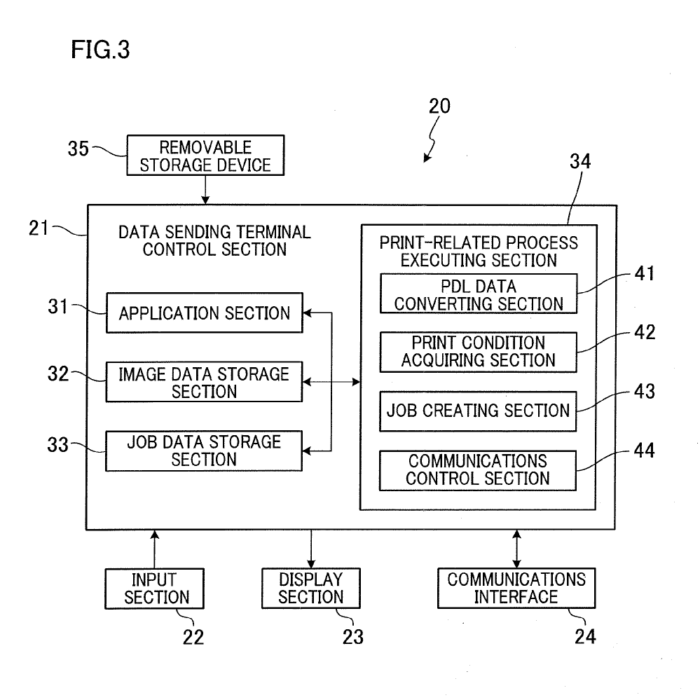

FIG. 3 is a functional block diagram of one of the data sending terminals shown in FIG. 1.

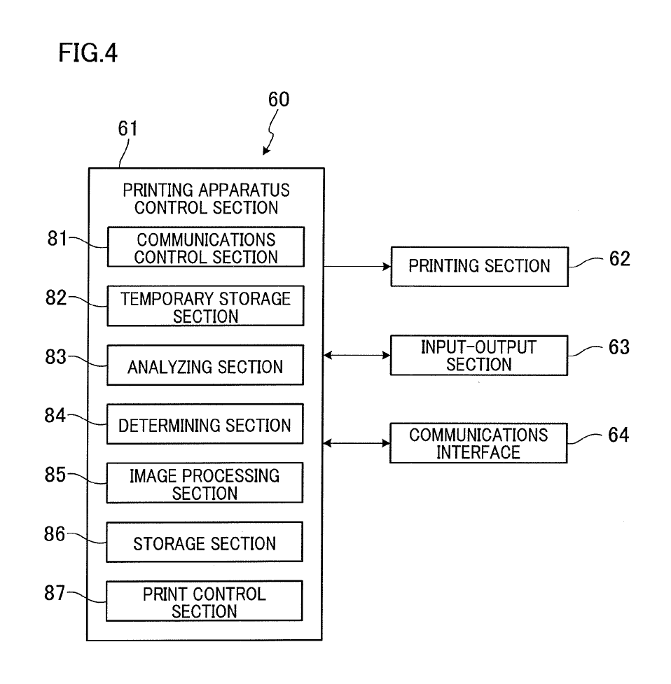

FIG. 4 is a functional block diagram of the printing apparatus shown in FIG. 1.

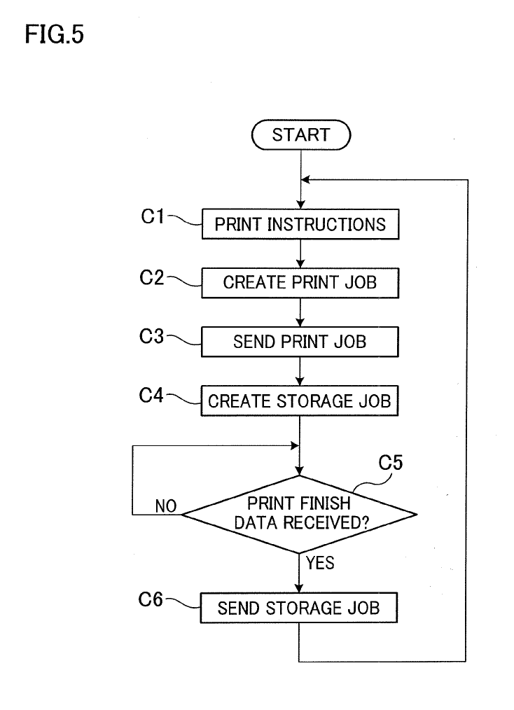

FIG. 5 is a control flowchart of one of the data sending terminals shown in FIG. 1.

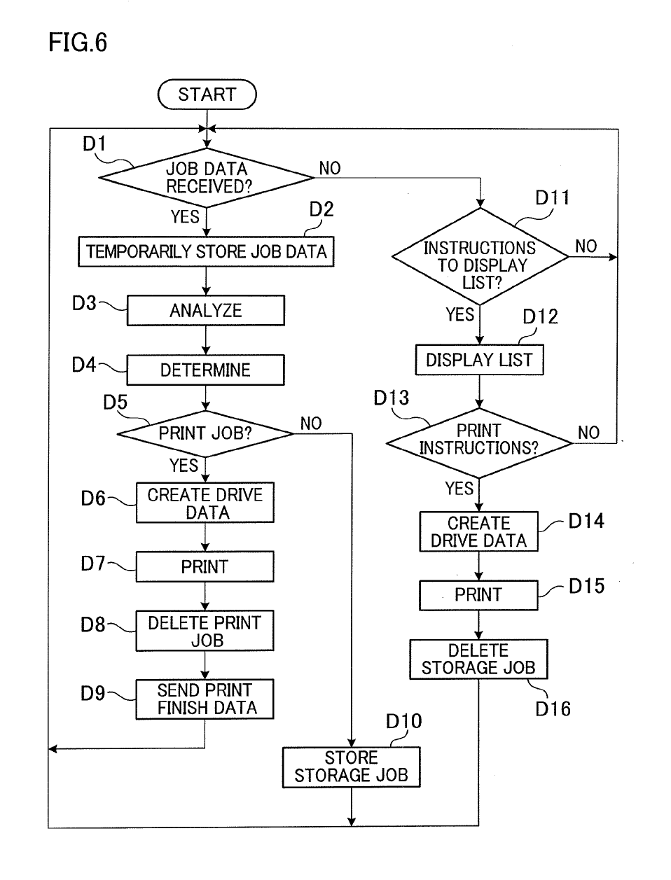

FIG. 6 is a control flowchart of the printing apparatus shown in FIG 1.

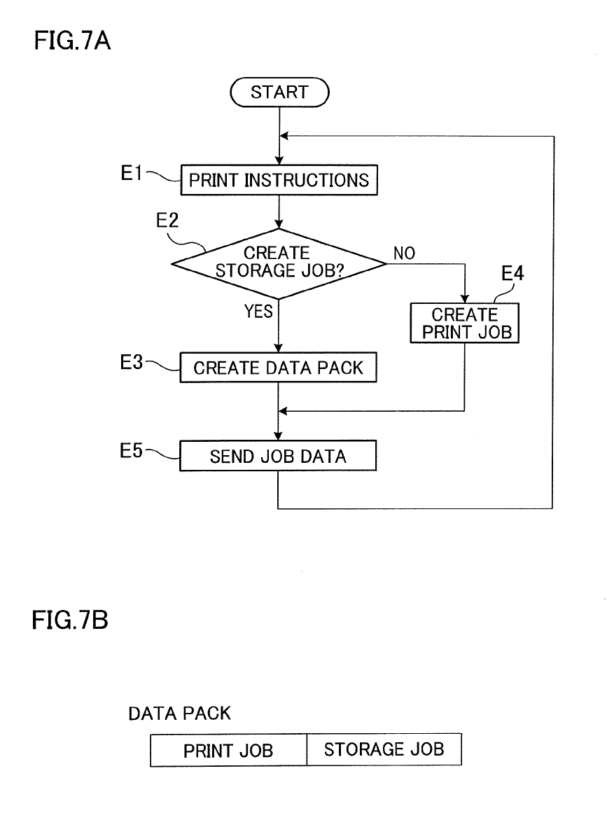

FIG. 7A is a control flowchart of a data sending terminal in a printing system according to Second Embodiment.

FIG. 7B is a diagram representing a data structure of a data pack.

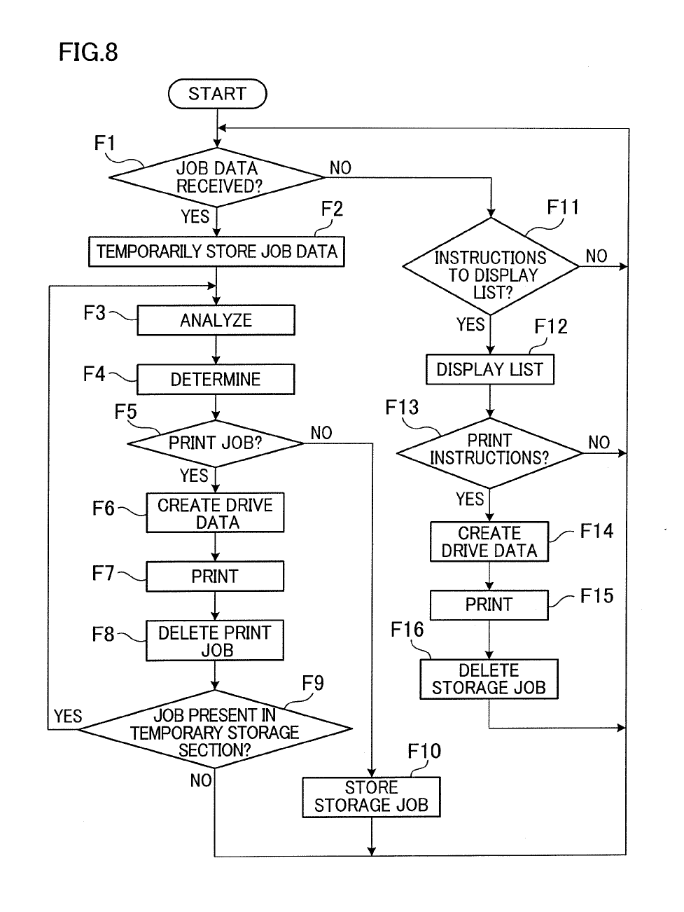

FIG. 8 is a control flowchart of a printing apparatus in the printing system according to Second Embodiment.

### DESCRIPTION OF THE PREFERRED EMBODIMENTS

A printing system 1 according to First Embodiment is described below with reference to FIGS. 1 to 6.

As illustrated in FIG. 1, the main components of the printing system l include data sending terminals 20, and a printing apparatus 60 communicably connected to the data sending terminals 20 via a network (such as WAN and LAN) 3. The printing system 1 has what is known as a reprinting function, whereby the image printed on a recording medium (for example, paper) in the printing apparatus 60 according to image data is reprinted in response to print instructions from a user.

The data sending terminals 20 are devices such as personal computers, and function to create image data according to operational input from a user. The data sending terminals 20 also function to create job data, specifically a print job and a storage job, from certain image data, and send these jobs to the printing apparatus 60. As used herein, the print job is a job for the printing of an image based on image data in the printing apparatus 60 immediately after the job data is received by the printing apparatus 60. The storage job is a job for the reprinting of an image based on image data in response to print, instructions from a user after the printing of the print job is finished in the printing apparatus 60 that has received the job data and stored it as a storage job.

As depicted in FIGS. 2A and 2B, the print job and the storage job each include a header and image data. The header of the print job includes a first print command (settings information such as paper size, number of copies, media type, and one-sided or two-sided printing in a print process concerning the print job, and a job identifier indicating that the job data is of the first print command (print job)), and attribute information of image data (information such as image data name, and image data author). On the other hand, the header of the storage job includes a second print command (settings information such as paper size, number of copies, media type, and one-sided or two-sided printing in a print process concerning the storage job, and a job identifier indicating that the job data is of the second print command (storage job)), and attribute information. The image data contained in the print job and the storage job created from the same image data have the same contents.

The printing apparatus 60 is provided for the printing of an image on a recording medium according to the image data contained in the job data received from the data sending terminals 20. When the incoming job data is a print job, the printing apparatus 60 prints an image on a recording medium according to the image data, using the first print command of the print job. On the other hand, when the incoming job data is a storage job, the printing apparatus 60 stores the storage job in a storage section 86 (described later). The printing apparatus 60 then prints an image on a recording medium according to the image data using the second print command contained in the storage job, after the printing of the print job is finished and in response to print instructions from a user.

The configuration of the data sending terminals 20 is described below. As represented in FIG. 3, each data sending terminal 20 includes a data sending terminal control section 21, an input section 22, a display section 23, and a communications interface 24.

The input section 22 is realized by, for example, a mouse or a keyboard, and receives various operational inputs from a user, and outputs the operational inputs to the data sending terminal control section 21. A user can make various inputs through the input section 22, including setting of the first print command for the print job, and setting of the second print command for the storage job. The display section 23 is realized by a liquid crystal display, and displays various settings screens and messages to a user according to the output display data from the data sending terminal control section 21.

The communications interface 24 serves as communications mean for external communications, including sending job data to the printing apparatus 60 via the network 3. In the present embodiment, the communications interface 24 constitutes a sending section.

The data sending terminal control section 21 is provided for controlling the operation of each section of the data sending terminal 20, and includes a CPU (Central Processing Unit), programs executed by the CPU (such as a printer driver), a ROM (Read Only Memory) rewritably storing data used for the programs, and a RAM (Random Access Memory) provided as the temporary storage of data during the execution of the programs. The functional sections constituting the data sending terminal control section 21 are accomplished by the cooperation of the hardware and the software stored in the ROM. The data sending terminal control section 21 includes an application section 31, an image data storage section 32, a job data storage section 33, and a print-related process executing section 34.

The application section 31 includes various types of software for creating, for example, documents, graphics and graphs, spreadsheets, and database, and creates image data by using the software according to user instructions.

The image data created in the application section 31 are stored in the image data storage section 32.

The print-related process executing section 34 includes a PDL data converting section 41, a print condition acquiring section 42, a job creating section 43, and a communications control section 44.

The PDL data converting section 41 converts the image data stored in the image data storage section 32 into PDL (Page Description Language) data that can be interpreted by the printing apparatus 60. The data conversion allows the image data to be sent from the data sending terminals 20 to the printing apparatus 60 in the smaller PDL data, and can shorten the communications time of the job data sent to the printing apparatus 60 with the image data.

The print condition acquiring section 42 causes a print dialog screen concerning print conditions to be displayed on the display section 23 upon receiving print condition setting instructions from a user via the input section 22. The display contents of the print dialog screen include dialogs used to set, for example, the first print command of the print job, and the second print command of the storage job. The print condition acquiring section 42 then creates print condition data according to user input concerning print conditions entered through the input section 22. As used herein, print condition data refers to subsidiary information concerning image data, and contain the first print command to be contained in the print job or the second print command to be contained in the storage job, and image data attribute information, as represented in FIG. 2C. Specifically, the print condition data is the header data of the print job and the storage job represented in FIG. 2A and FIG. 2B.

The job creating section 43 individually creates the job data, specifically the print job and the storage job, from certain image data. Specifically, the job creating section 43 creates the print job and the storage job from the PDL data converted in the PDL data converting section 41 and the print condition data created in the print condition acquiring section 42. In the present embodiment, the job creating section 43 creates the storage job after creating the print job.

The communications control section 44 controls the communications interface 24 for the communications of various data with the printing apparatus 60. Specifically, the communications control section 44 controls the communications interface 24 in such a manner that the print job and the storage job created from the same image data are sent to the printing apparatus 60 in this order.

The print job and the storage job created in the job creating section 43 are stored in the job data storage section 33.

The printer driver stored in the ROM of the data sending terminal 20 can cause the data sending terminal 20 to execute functions concerning the job creating section 43, and functions concerning the sending of the print job and the storage job to the printing apparatus 60 performed by the communications control section 44. In the present embodiment, the printer driver stored in the ROM of the data sending terminals 20 is installed from a removable storage device 35 storing the printer driver. The removable storage device 35 is a non-transitory computer readable medium, for example, such as a CD-ROM (Compact Disc Read Only Memory), a flexible disk (FD), and a magneto optical (MO). As a variant, the non-transitory computer readable medium storing the printer driver may be a fixed storage device such as a hard disk.

The following describes the configuration of the printing apparatus 60. As represented in FIG. 4, the printing apparatus 60 includes a printing apparatus control section 61, a printing section 62, an input-output section 63, and a communications interface 64.

Under the control of the printing apparatus control section 61, the printing section 62 prints an image on a recording medium according to the image data contained in the job data. The input-output section 63 is realized by, for example, a touch panel, and displays information such as various settings screens and messages to a user according to the input display data from the printing apparatus control section 61. The input-output section 63 receives user's operational input, and outputs the operational input to the printing apparatus control section 61. The communications interface 64 serves as communications mean for external communications such as receiving job data from the data sending terminals 20 via the network 3. In the present embodiment, the communications interface 64 and the input-output section 63 constitute a receiving section and an instruction receiving section, respectively.

The printing apparatus control section 61 is provided for controlling the operation of each section of the printing apparatus 60, and includes a CPU (Central Processing Unit), programs executed by the CPU, a ROM (Read Only Memory) rewritably storing data used for the programs, and a RAM (Random Access Memory) provided as the temporary storage of data during the execution of the programs. The functional sections constituting the printing apparatus control section 61 are accomplished by the cooperation of the hardware and the software stored in the ROM. The printing apparatus control section 61 includes a communications control section 81, a temporary storage section 82 for temporarily storing the job data, an analyzing section 83, a determining section 84, an image processing section 85, a storage section 86 for storing the job data, and a print control section 87. The temporary storage section 82 is a volatile memory such as a RAM, whereas the storage section 86 is a nonvolatile memory such as a HDD.

The communications control section 81 controls the communications interface 64 for the communications of various data with the data sending terminals 20. For example, upon receiving job data via the communications interface 64, the communications control section 81 stores the job data in the temporary storage section 82.

The analyzing section 83 analyzes the job data temporarily stored in the temporary storage section 82, in the order received, by the communications interface 64. Specifically, the analyzing section 83 analyzes whether the job data temporarily stored in the temporary storage section 82 includes the first print command or the second print command.

The determining section 84 uses the result of the analysis by the analyzing section 83 to determine whether the analyzed job data is the print job or the storage job. Specifically, the determining section 84 determines that the job data is the print job when the result of the analysis by the analyzing section 83 indicates that the job data includes the first print command. On the other hand, when the result of the analysis by the analyzing section 83 indicates that the job data includes the second print command, the determining section 84 determines that the job data is the storage job, and the storage job is stored in the storage section 86.

The image processing section 85 converts the image data (PDL data) included in the print job and the storage job into drive data for the printing section 62. For example, when the printing section 62 is an inkjet head, the drive data represents the amount of the ink ejected per unit area of a recording medium from the inkjet head, and the print data (PDL data) is converted into the drive data by using a known error diffusion process or some other technique. When the printing apparatus 60 is a common laser printer, conversion is made from image data (PDL data) into the drive data (drive data for a laser recording section) by using a technique such as the known dithering. The drive data is not limited to the quantitative data (for example, an ink amount, a density value, or print data as it is called) recorded per unit area of a recording medium, and may contain data used to control the driving of the printing section 62.

When the job data temporarily stored in the temporary storage section 82 is determined as being the print job by the determining section 84, the print control section 87 controls the printing section 62 and prints an image on a recording medium according to the image data (image data converted into the drive data by the image processing section 85) included in the print job, using the first print command of the print job.

Upon receiving print instructions for the storage job stored in the storage section 86 from a user via the input-output section 63, the print control section 87 controls the printing section 62 and prints an image on a recording medium according to the image data (image data converted into the drive data by the image processing section 85) included in the storage job, using the second print command of the storage job.

The following describes a control flow of the data sending terminal 20, with reference to FIG. 5.

First, upon the print-related process executing section 34 receiving print instructions for the image data stored in the image data storage section 32 through the input section 22 (C1), the job creating section 43 creates a print job from the image data (C2: job creating step). The print job includes the image data (image data converted to PDL data by the PDL data converting section 41) stored in the image data storage section 32, print condition data associated with the image data, and attribute information. The print job so created is stored in the job data storage section 33.

Then, the communications control section 44 controls the communications interface 24 and sends the job data of the created print job (print job stored in the job data storage section 33) to the printing apparatus 60 (C3: sending step). Because the print job is created and sent to the printing apparatus 60 before creating a storage job, the print job can be printed at high speed without delay.

Thereafter, the job creating section 43 creates a storage job from the same image data used to create the print job in step C2 (C4: job creating step). The storage job includes the image data (image data converted to PDL data by the data converting section 41) stored in the image data storage section 32, print condition data associated with the image data, and attribute information. The storage job so created in stored in the job data storage section 33.

The communications control section 44 then determines whether the communications interface 24 has received print finish data from the printing apparatus 60 (C5). Here, the print finish data is the data indicating that the print process concerning the print job has been finished in the printing apparatus 60.

The process of step CS is repeated if it is determined that the communications control section 44 has not received the print finish data (C5: NO). On the other hand, if it is determined that the print finish data has been received (C5: YES), the communications control section 44 controls the communications interface 24 and sends job data for the created storage job (storage job stored in the job data storage section 33) to the printing apparatus 60 (C6; sending step). The sequence then returns to step C1. In this manner, sending of the storage job to the printing apparatus 60 is performed after the print process concerning the print job is finished in the printing apparatus 60. Because the process of receiving the storage job does not take place while the print process concerning the print job is in progress in the printing apparatus 60, the process load on the printing apparatus can be reduced. This makes it possible to print the print job at high speed. The control flow of the data sending terminal 20 proceeds in the manner described above.

The control flow of the printing apparatus 60 is described below with reference to FIG. 6. First, it is determined whether the communications control section 81 has received job data from the data sending terminals 20 via the communications interface 64 (D1; receiving step). If it is determined that the job data has been received (D1: YES), the communications control section 81 stores the received job data in the temporary storage section 82 (D2: temporary storage step). The analyzing section 83 then refers to the job data stored. in the temporary storage section 82 and analyzes whether the job data includes the first print command or the second print command (D3: analyzing step).

Thereafter, the determining section 84 determines whether the analyzed job data is the print job or the storage job, using the result of the analysis by the analyzing section 83 (D4: determining step). Specifically; the determining section 84 determines that the job data is the print job if the result of the analysis by the analyzing section 83 indicates that the job data includes the first print command. On the other hand, the job data is determined as being the storage job if the result of the analysis by the analyzing section 83 indicates that the job data includes the second print command.

In the next step D4, if it is determined in the determining section 84 that the job data is the print job (D5: YES), the image processing section 85 converts the image data (PDL data) included in the job data (print job) into the drive data (D6). The print control section 87 then controls the printing section 62 and prints an image on a recording medium according to the image data (drive data), using the first print command included in the print job (D7: printing step). The print control section 87 then deletes (discards) the printed print job from the temporary storage section 82 (D8: discarding step). Thereafter, the communications control section 81 controls the communications interface 64 and sends print finish data to the data sending terminal 20 that has sent the job data (D9), and the sequence returns to step D1.

If the determining section 84 determines in step D4 that the job data is the storage job (D5: NO), the determining section 84 stores the job data (storage job) in the storage section 86 (D10: storing step), and the sequence returns to step D1 after deleting the stored storage job from the temporary storage section 82.

If it is determined in step D1 that the communications control section 81 has not received the job data (D1: NO), the print control section 87 determines whether storage job listing and displaying instructions have been received from a user via the input-output section 63 (D11). The sequence returns to step D1 if it is determined that the storage job listing and displaying instructions have not been received (D11: NO).

On the other hand, if it is determined that the storage job listing and displaying instructions have been received (D11: YES), the print control section 87 extracts attribute information included in the storage job stored in the storage section 86, and causes the input-output section 63 to display a list of the image data names included in the attribute information (D12). The print control section 87 then determines whether a storage job (image data name) to be executed in the printing section 62 has been selected via the input-output section 63 (D13). The sequence returns to step D1 if a storage job is not selected (D13: NO).

On the other hand, if a storage job has been selected (D13: YES), the selection is deemed as being print instructions for the selected storage job, and the image processing section 85 converts the image data included in the storage job into the drive data (D14). The print control section 87 then controls the printing section 62 and prints an image on a recording medium according to the image data (drive data), using the second print command included in the storage job (D15: storage job printing step). Thereafter, the print control section 87 deletes (discards) the printed storage job from the storage section 86 (D16), and the sequence returns to step D1. The control flow of the printing apparatus 60 proceeds in the manner described above.

In the First Embodiment described above, the storage job is created in the data sending terminal 20, and rewriting of the print job into the storage job is not necessary in the printing apparatus 60. This enables fast printing of the print job in the printing apparatus 60. Further, because the print job and the storage job created from the same image data are sent to the printing apparatus 60 in this order, the print job can be printed at high speed without delay.

Further, because the job creating section 43 creates the job data separately for the print job and the storage job, the job data for the print job can be created in advance and sent to the printing apparatus 60 in response to user's print instructions in the data sending terminal 20. This makes it possible to print the print job at high speed without delay. Further, because the storage job can be sent while the printing apparatus 60 and the data sending terminals 20 are not busy, the process load on the printing apparatus 60 and the data sending terminals 20 can be reduced.

Further, because the storage job is stored in the storage section 86 after the printing of the print job is finished, the print job can be printed at high speed without delay. Further, because the storing of the storage job does not take place while the printing of the print job is in progress, the process load on the printing apparatus 60 can be reduced.

Second Embodiment is described below with reference to FIGS. 7A and 7B and FIG. 8. Second Embodiment differs from First Embodiment in that, unlike First Embodiment in which the job creating section 13 of the data sending terminal 20 creates the job data separately for the print job and the storage job, the job creating section 43 in Second Embodiment integrally creates the job data for the print job and the storage job. Another difference is that the job data is created for the print job and the storage job only when a user has entered a setting for the creation of the storage job, and that the job data is created only for the print job in the absence of a setting for the creation of the storage job. This is different from First Embodiment in which the job creating section 43 always creates the job data for the print data and the storage data with regard to the image data for which a print command has been received. The settings information for the creation of the storage job is acquired by the print condition acquiring section 42. In the following, the same reference numerals are used for the components and/or features already described in the foregoing First Embodiment, and further explanations thereof are omitted as appropriate.

In the present embodiment, the job creating section 43 of the data sending terminal 20 creates a data pack as the integral job data for the print job and the storage job when a user has entered a setting for the creation of the storage job, as represented in FIG. 7B. The job creating section 43 constructs the data pack in order from the job data for the print job to the job data for the storage job. Specifically, the job creating section 43 creates the data pack in a manner that places the job data for the print job in front of the job data for the storage job.

The communications control section 44 of the data sending terminal 20 controls the communications interface 24 in such a manner that the data pack is sent to the printing apparatus 60 in order from the portion including the job data for the print job to the portion including the job data for the storage job.

The following describes the control flow of the data sending terminal 20 according to Second Embodiment, with reference to FIG. 7A.

First, upon the print-related process executing section 34 receiving print instructions via the input section 22 for the image data stored in the image data storage section 32 (E1), the job creating section 43 refers to the settings information concerning creation of a storage job and acquired by the print condition acquiring section 42, and determines whether to create a storage job for the image data stored in the image data storage section 32 (E2). If it is determined to create a storage job (E2: YES), the job creating section 43 creates a data pack as the integral job data for the print job and the storage job from the image data (E3: job creating step). The sequence then goes to step E5.

On the other hand, if it is determined in step E2 not to create a storage job (E2: NO), the job creating section 43 creates the job data only for the print job from the image data (E4), and the sequence goes to step E5.

In step E5, the communications control section 44 controls the communications interface 24 and sends the data pack created in step E3 or the job data created in step E4 to the printing apparatus 60 (sending step). Because the storage job is sent to the printing apparatus 60 in the form of a data pack integral with the print job, the job data communications between the data sending terminals 20 and the printing apparatus 60 need to be performed less often. The sequence returns to step E1 after the process of step E5 is finished. The control flow of the data sending terminals 20 proceeds in the manner described above.

The control flow of the printing apparatus 60 according to Second Embodiment is described below with reference to FIG. 8. First, it is determined whether the communications control section 81 has received the job data from the data sending terminal 20 via the communications interface 64 (F1: receiving step). If it is determined that the job data has been received (F1: YES), the communications control section 81 stores the received job data in the temporary storage section 82 (F2: temporary storage step). Note that the communications interface 64 receiving the data pack receives the portion including the job data for the print job before the portion including the job data for the storage job.

Then, the analyzing section 83 refers to the job identifier included in the job data received first by the communications interface 64 from among the job data stored in the temporary storage section 82, and analyzes whether the job data includes the first print command or the second print command (F3: analyzing step). The sequence then goes to step F4.

The processes of steps F4 to F8 and step F10 are substantially the same as those of steps D4 to D8 and step D10, and will not be described further. After step F8, the analyzing section 83 determines whether job data is stored in the temporary storage section 82 (F9). The sequence returns to step F3 if it is determined that job data is stored (F9: YES). The sequence returns to step F1 if it is determined that job data is not stored (F9: NO).

The sequence goes to step F11 if it is determined in step F1 that the communications control section 81 has not received data pack or job data (F1: NO). The processes of steps F11 to F16 are substantially the same as those of steps D11 to D16, and will not be described further. The control flow of the printing apparatus 60 proceeds in the manner described above.

In the Second Embodiment described above, the data pack as the integral job data for the print job and the storage job is sent from the data sending terminals 20 to the printing apparatus 60, and accordingly the job data communications between the data sending terminals 20 and the printing apparatus 60 need to be performed less often.

Further, because the storage job is stored in the storage section 86 after the printing of the print job is finished, the print job can be printed at high speed without delay. Further, because the storing of the storage job does not take place while the printing of the print job is in progress, the process load on the printing apparatus 60 can be reduced.

The foregoing embodiments have been described through the case where a user can make settings for the second print command included in the storage job as with the case of the first print command. However, the second print command may have only simple settings in the data sending terminals 20, and more detailed print settings may be made in the printing apparatus 60. In this case, printing can be executed under the conditions desired by a user at the time of actual printing.

Further, unlike the foregoing First Embodiment in which the storage job is created after creating the print job, the storage job may be created before creating the print job. Further, unlike the foregoing First Embodiment in which the storage job is created after sending the print job to the printing apparatus 60, the storage job may be created before sending the print job to the printing apparatus 60. In these cases, the communications control section 44 may be adapted to control the communications interface 24 in a manner that allows the print job to be sent to the printing apparatus 60 before the storage job.

Further, the image data included in the print job sent from the data sending terminals 20 to the printing apparatus 60 may be drive data, instead of the PDL data as described in the foregoing embodiments. For example, the image data included in the print job sent from the data sending terminal 20 to the printing apparatus 60 may be drive data when the process time as the difference of the communication time required for sending the drive data from the data sending terminal 20 to the printing apparatus 60 and the communication time required for sending the PDL data is shorter than the process time for the conversion of the PDL data to the drive data in the image processing section 85.

When the data sending terminal 20 received more than one print commands for different image data, the storage job for each image data may be sent after sending the print jobs for these image data.

The data sending terminals 20 may be portable terminals. In this case, the data sending terminals 20 and the printing apparatus 60 are linked by wireless communications.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting, Various changes may be made without departing from the spirit and scope of the invention as defined in the following

What is claimed is:

1. A printing system comprising a printing apparatus and a data sending terminal configured to send data to the printing apparatus,
wherein the data sending terminal includes:
a job creating section configured to create job data from image data, the job data being created as a print job that includes the image data and a first print command, and as a storage job that includes the image data and a second print command;
a sending section configured to send the job data to an outside; and
a data sending terminal control section configured to control the data sending terminal, and
wherein the printing apparatus includes:
a receiving section configured to receive the job data from the outside;
an analyzing section configured to analyze the job data;
a determining section configured to determine whether the analyzed job data is the print job or the storage job using a result of the analysis by the analyzing section;
a printing section configured to print an image on a recording medium according to the image data included in the job data;
a storage section configured to store the job data; and
a printing apparatus control section configured to control the printing apparatus,
the data sending terminal control section controlling the sending section in such a manner that the print job and the storage job created from the same image data are sent to the outside in this order,
the printing apparatus control section controlling the analyzing section to analyze the job data received by the receiving section in the order received by the receiving section, the printing section to print an image on a recording medium according to the image data of the print job using the first print command of the print job when the determining section determines the job data analyzed by the analyzing section is the print job, and the storage section to store the storage job when the determining section determines the job data analyzed by the analyzing section is the storage job.

2. The printing system according to claim 1,
wherein the analyzing section analyzes whether the job data includes the first print command or the second print command, and
wherein the determining section determines that the job data is the print job when the analyzing section analyzes the job data includes the first print command, and that the job data is the storage job when the analyzing section analyzes the job data includes the second print command.

3. The printing system according to claim 1,
wherein the job creating, section integrally creates the job data for the print job and the job data for the storage job in a manner that arranges the job data for the print job prior to the job data for storage job, and
wherein the data sending terminal control section controls the sending, section so that the integral job data for the print job and the storage job created in the job creating section are sent to the printing apparatus in order from a portion including the job data for the print job to a portion including the job data for the storage job.

4. The printing system according to claim 1,
wherein the job creating section separately creates the job data for the print job and the job data for the storage job, and
wherein the data sending terminal control section controls the sending section so that the job data for the print job and the job data for the storage job separately created in the job creating, section are sent to the priming apparatus in this order.

5. The printing system according to claim 3, further comprising:
a temporary storage section configured to temporarily store the job data for the print job and the job data for the storage job received by the receiving section,
wherein the printing apparatus control section controls the printing section so as to print an image on a recording medium according to the image data included in the print job stored in the temporary storage section, and the storage section to store the storage job stored in the temporary storage section after the printing of the print job.

6. The printing system according to claim 1, further comprising:
an instruction receiving section configured to receive print instructions for the storage job stored in the storage section from the outside,
wherein the printing apparatus control section controls the printing, section so as to print an image on a recording medium according to the image data of the storage job when the print instructions is input to the instruction receiving section, using the second print command included in the storage job stored in the storage section.

7. A printing method executed by a printing system that includes a printing apparatus and a data sending terminal configured to send data to the printing apparatus,
the method comprising:
a job creating step executed by the data sending terminal of creating job data from image data, the job data being created as a print job that includes the image data and a first print command, and as a storage job that includes the image data and a second print command;
a sending step executed by the data sending terminal of sending to the printing apparatus the job data created in the job creating step;
a receiving step executed by the printing apparatus of receiving the job data sent in the sending step;
an analyzing step executed by the printing apparatus of analyzing the job data received in the receiving step;
a determining step executed by the printing apparatus of determining whether the analyzed job data is the print job or the storage job using a result of the analysis performed in the analyzing step;
a printing step executed by the printing apparatus of printing an image on a recording medium according to the image data of the print job using the first print command of the print job when the determining step determines that the job data sent from the data sending terminal is the print job; and
a storing step executed by the printing apparatus of storing the storage job in a storage section when the determining step determines that the job data sent from the data sending terminal is the storage job,
the print job and the storage job created from the same image data being sent to the printing apparatus in this order in the sending step,
the job data received in the receiving step being analyzed in the analyzing step in the order received in the receiving step.

8. The printing method according to claim 7,
wherein the analyzing step analyzes whether the job data includes the first print command or the second print command, and
wherein the determining step determines that the job data is the print job when the analyzing step analyzes that the job data includes the first print command, and that the job data is the storage job when the analyzing step determines that the job data includes the second print command.

9. The printing method according to claim 7,
wherein the job creating step integrally creates the job data for the print job and. the job data for the storage job in a manner that arranges the job data for the print job prior to the job data for storage job, and
wherein the sending step sends the integral job data for the print job and the storage job created in the job creating step to the printing apparatus in order from a portion including the job data for the print job to a portion including the job data for the storage job.

10. The printing method according to claim 7,
wherein the job creating step separately creates the job data for the print job and the job data for the storage job, and
wherein the sending step sends the job data for the print job and the job data for the storage job separately created in the job creating step to the printing apparatus in this order.

11. The printing method according to claim 9, further comprising a temporary storage step of temporarily storing in a temporary storage section the job data for the print job and the job data for the storage job received, in the receiving step,
wherein the analyzing step analyzes the job data stored in the temporary storage section,
wherein the printing step prints an image on a recording medium according to the image data included, in the print job stored in the temporary storage section, and
wherein the storing step stores in the storage section the storage job stored in the temporary storage section after the print job stored in the temporary storage section is printed in the printing step.

12. The printing method. according to claim 7, further comprising:
a discarding step of discarding the print job for the printing step from e printing apparatus after the printing step; and
a storage job printing step of printing an image on a recording medium according to the image data of the storage job after the discarding step and in response to input of a print command to the printing apparatus, using the second print command included in the storage job stored in the storage section in the storing step.

13. A non-transitory computer readable medium storing a printer driver that causes a data sending terminal sending data to a printing apparatus to execute:
a job creating step of creating job data from image data, the job data being created. as a print job that includes the image data and a first print command, and as a storage job that includes the image data and a second print command; and
a sending step of sending to the printing apparatus the job data created in the job creating step, wherein the print job and the storage job created from the same image data are sent to the printing apparatus in this order.

14. A printing system, comprising a printing apparatus and a data sending terminal configured to send data to the printing apparatus,
wherein the data transmitting terminal includes:
a processor configured to create job data from image data, the job data being created as a job data for print job that includes the image data and a first print command, and as a job data for storage job that includes the image data and a second print command; and
a transmitter configured to transmit the job data to the printing apparatus,
wherein the processor controls the transmitter to transmit the job data for the print job and. the job data for the storage job, in this order, created from the same image data to the printing apparatus, and
wherein the printing apparatus includes:
a receiver configured to receive the job data;
a printing head configured to print an image on a recording medium according to the image data included in the job data;
a storage unit configured to store the job data; and
a processor configured to;
control the printing head to print an image on a recording medium according to the image data of the job data for the print job using the first print command of the job data for the print job when the received job data is the job data for the print job, and
control the storage unit o store the job data for the storage job when the received job data a is the job data for the storage job.
